(19) United States
(12) Patent Application Publication
(10) Pub. No.: US 2011/0201980 A1
(43) Pub. Date: Aug. 18, 2011

(54) METHOD AND A DEVICE FOR ABDOMINALLY STABILIZING PATIENT

(76) Inventor: Öyvind Reitan, Lund (SE)

(21) Appl. No.: 13/124,430

(22) PCT Filed: Oct. 5, 2009
(86) PCT No.: PCT/SE09/00437

§ 371 Date: Apr. 15, 2011

(30) Foreign Application Priority Data
Oct. 17, 2008 (SE) 0802212-1

(51) Int. Cl. A61H 31/00

(52) U.S. Cl. 601/41

(57) ABSTRACT

A method of abdominally stabilizing a patent selected for CardioPulmonary Resuscitation (CPR) and whose chest is in an uncompressed state includes wrapping a substantially inextensible flexible belt around the abdomen substantially without applying pressure to the abdomen, and locking the belt in the wrapped position. Also disclosed is a belt for abdominal stabilization.

### FIELD OF THE INVENTION

The present invention relates to an abdominal support for use in CardioPulmonary Resuscitation (CPR) and a method of stabilizing the abdominal volume of a person during CPR.

### BACKGROUND OF THE INVENTION

In CPR compressions are administered at a more or less regular rate, such as at 60 per minute or 100 per minute or more to the chest of a person in need of resuscitation. The compressions are generally administered perpendicularly to the sternum. They can be administered by hand or by a dedicated CPR apparatus, such as the transportable CPR apparatus marketed under the trade mark Lucas™ by Jolife A B, Lund, Sweden. The Lucas™ apparatus comprises a reciprocating piston driven by compressed air. A disk mounted at the end of the piston rod proximal to the patient is made to abut the chest of the patient above the portion of the sternum adjacent to the xiphoid process. The compressions to the patient's chest are administered via this disk at a stroke of about 40 mm to 50 mm. Due to the thus increased intra-thoracic pressure blood present in, i.a., the chambers of the heart and air present in the lungs is expelled. By the resilient nature of the chest the chambers of the heart and the lungs are again filled with blood and air, respectively, during retraction of the piston rod.

A problem with the administration of such compressions is a persistent loss of contractile force of the heart muscle. In regard of the left ventricle such loss has been observed in experiments with pigs (S W Downing et al., The stretched ventricle. Myocardial creep and contractile dysfunction after non-ischemic left ventricular distention. J Thorac Cardiovasc Surgery 104(4) (1992) 996-1005). A corresponding persistent loss of contractile force has also been observed for the right ventricle (C Greyson et al., Right ventricular pressure and dilation during pressure overload determine dysfunction after pressure overload. Am J Physiol Heart Circ Physiol 278(2000) H1414-H1420. Another problem with the administration of compressions to the chest in CPR is the damage to the patient's ribs and sternum, in particular in elderly patients. Broken ribs may, in turn, damage adjacent tissues, in particular the lungs, with severe consequences. Coronary perfusion and output levels, which are critical for successful CPR, are related to chest compression levels (depth). According to prevailing standards, for an adult CPR patient a compression depth of from about 40 mm to about 50 mm is considered an acceptable compromise between stimulating coronary perfusion and output, and putting the integrity of the thoracic cage at risk.

U.S. Pat. No. 4,424,806 A discloses an automated ventilation, CPR and circulatory assistance apparatus comprising a vest including an inflatable bladder and an abdominal restraint including another inflatable bladder. Pneumatic control apparatus for controlling the vest, the abdominal restraint and the airways are in fluid communication with the bladders and the airway apparatus and accomplish alternate inflation and deflation of the patient's lungs and the bladders.

U.S. Pat. No. 4,349,015 A discloses a manually actuable CPR apparatus comprising a bellows to be placed on the chest of a patient coupled by a conduit and valve means to the patient's airway. The CPR apparatus accordingly functions to pressurize the patient's lungs at the same time as the patient's chest is being compressed by force transmitted through the bellows. The apparatus is provided with an inflatable bladder kept in abutment with the patient's belly by a flat abdominal belt. The bladder is in communication with the bellows via a conduit and expanded by compression of the bellows.

U.S. Pat. No. 4,397,306 A discloses an integrated system for cardiopulmonary resuscitation comprising chest compression means, lung ventilation means including valve operation means, means for restricting the abdomen to exert pressure on the abdominal wall, and automatically operable control means for selectively operating the chest compression means, the lung ventilating/valve operation means and the abdomen restricting means in a predetermined selected sequence. The abdomen restricting means comprise abdominal garment and an inflatable bladder within the garment.

U.S. Pat. No. 7,104,967 B2 discloses an inflatable vest for cardiopulmonary resuscitation and for cardiac assist. The vest comprises or consists of a belt of inextensible material for wrapping around the chest of a patient and a removable, inflatable bladder for placement between the chest and the belt. When inflated the bladder applies circumferential pressure to the chest. Cyclical inflation and deflation of the bladder increases and decreases, respectively, intrathoracic pressure with the aim of making blood pass through the heart and other organs.

### OBJECTS OF THE INVENTION

An object of the present invention is to devise a CPR method of intermittently raising the intra-thoracic pressure in a patient that is more efficient than methods known in the art, while not increasing the risk of damage to the thoracic cage.

Another object of the present invention is to devise a CPR method of intermittently raising the intra-thoracic pressure in a patient under CPR of same efficiency as methods known in the art at a reduced risk of damage to the thoracic cage.

A further object of the invention is to provide a means for use in these methods.

A still further object of the invention is to devise a CPR method of intermittently raising the intra-thoracic pressure in a patient under CPR of same efficiency as methods known in the art but improved in regard of preserving the contractile force of the heart muscle.

Still another object of the invention is to devise a CPR method of intermittently raising the intra-thoracic pressure in a patient under CPR of same efficiency as methods known in the art but improved in regard of preserving the integrity of the thoracic cage.

Additional objects of the invention will be evident from the following summary of the invention, the description of a number of preferred embodiments thereof illustrated in a drawing, and the appended claims.

### SUMMARY OF THE INVENTION

The present invention departs from the observation that, during the compression phase of CPR, the belly expands in correspondence to the compression of the thoracic cage. A substantial portion of the pressure exerted on the sternum and ribs is transmitted to the abdomen. Considerable compression effort thus is lost.

The present invention is based on the hypothesis that artificially encaging (stabilizing) the abdomen similar to the natural encaging of the lungs and the heart by the thoracic cage should prevent encaged thoracic tissues from being displaced in an abdominal direction and thereby strained. In addition, restraining the combined thoracic and abdominal volume in this manner should enhance cardiac output, blood pressure and ventilation. In an abdominally stabilized patient pressure leakage out of the encaged tissue compartments should be mainly by the airways (air) and blood (blood vessels and heart chambers) and, therefore, increase oxygen uptake of the lungs and oxygenation of venous blood. The increased intra-abdominal pressure in the encaged abdomen results in increased venous return to the heart and thus an enhancement of circulatory efficiency. Last not least, abdominal stabilization allows the compression depth to be reduced at maintained compression efficiency. Thereby the strain on the ribs and the soft tissues of the chest, in particular the heart, is reduced, and persistent loss of ventricular contractility prevented. As a result the contractile force of the heart muscle is preserved.

According to the present invention thus is disclosed a method of stabilizing or preserving the abdominal volume of a patient under CPR by enclosing the abdomen in a substantially non-extensible envelope or belt of a flexible material, wherein the envelope does not comprise an inflatable member such as an inflatable bladder. The abdomen is enclosed in the envelope in an uncompressed state.

The method of the invention is substantially different from abdominal binding methods known in the art. In these prior art methods the abdomen of a patient under CPR is put under continuous pressure during CPR (G P Lilja et al., Augmentation of systolic blood pressure during external cardiac compression by use of the MAST suit. Ann Emerg Med 10 (1981) 182) or under intermittent pressure (B D Manhoney et al., Pneumatic trousers in refractory prehospital cardiac arrest. Ann Emerg Med 13 (1984) 401) by the abdominal enclosure. In prior art abdominal binding pressure is applied to the abdomen independent of thoracic compression. Prior art devices for abdominal stabilization generally rely on expandable bladders that stay inflated during administration of CPR or are inflated/deflated over a compression/decompression cycle.

According to the present invention is also disclosed a method of preserving the integrity of the thoracic cage in a patient selected for CPR by means of a CPR apparatus designed to administer periodical compressions to the patient's chest, preservation of integrity being accomplished by reducing the depth of compression of the chest at maintained compression efficiency, comprising abdominally stabilizing the patient in a condition in which the patient's chest is in an uncompressed state by wrapping a substantially inextensible flexible support belt around the patient's abdomen substantially without applying pressure to the abdomen to enclose the abdomen in the tightly fitting belt; locking the belt in the wrapped position, administering compressions to the patient's chest, wherein the belt does not comprise an inflatable member such as an inflatable bladder. By the integrity-preserving method of the invention the depth of thoracic compression can be reduced by 5 percent and even 10 percent while maintaining intra-thoracic pressure at the same level as in absence of abdominal stabilization. Such a reduction in compression depth corresponds to a substantially reduced risk of damage to the thoracic cage and/or the heart muscle, such as a risk reduction of 25 percent or more.

According to the present invention is furthermore disclosed a method of increasing cardiac output and blood pressure in CPR administered to a patient at a maintained compression depth, comprising abdominally stabilizing the patient in a condition in which the patient's chest is in an uncompressed state by wrapping a substantially inextensible flexible support belt around the patient's abdomen substantially without applying pressure to the abdomen to enclose the abdomen in the tightly fitting belt; locking the belt in the wrapped position, administering compressions to the patient's chest, wherein the belt does not comprise an inflatable member such as an inflatable bladder. “Maintained compression depth” relates to the compression depth in CPR administered in absence of a support belt. This method allows cardiac output to be increased by 5% or more and even by 10% or more.

According to the present invention is disclosed a means for artificially encaging or positionally stabilizing the soft tissues of the abdomen in a patient under CPR, so as to prevent tissues encaged by the chest from being displaced in an abdominal direction and thereby strained and/or to provide for a reduced compression depth at maintained compression efficiency and reduced risk of damage to the thoracic cage.

The stabilizing means according to the invention is an abdominal support belt of a flexible material sized for circumferential disposition around the abdomen of a person to receive CPR treatment, the belt having a first end and a second end and an outer face and an inner face, co-operating first and second means for releaseably attaching the belt around the abdomen, the first means being disposed in proximity of the first end and the second means being disposed along the outer face. The flexible material and thus the abdominal support belt is preferably substantially non-extendable in a circumferential direction. In this application “substantially non-extendable” comprises an extension of up to 1.0%, preferably of up to 0.5%, in a circumferential direction at a load which the mounted belt of the invention does experience during CPR. A preferred material for the belt is woven polyester or polyamide. Preferred fixation means include patches of Velcro™ material, hooks and eyes, belt buckles, and not setting adhesive such as adhesive used for medical tape.

For an adult person the preferred width of the abdominal support belt of the invention is from 15 cm to 40 cm, preferably from about 20 cm to about 30 cm, the preferred length being at least equal to the circumference of the waist, such as from 80 cm to 120 cm, preferably from 100 cm to 140 cm or more to provide for an overlap in a mounted position. The abdominal support belt of the invention should be flexible to allow it to adapt to the abdomen of the person under CPR; its thickness is not critical but will normally be in the range of 0.5 mm to 2 mm. It is particularly preferred for the abdominal support belt of the invention to enclose the trunk in a caudal direction from about the free end of the xiphoid process to about the iliac crest. More particularly preferred is an extension of the abdominal support belt of the invention in a caudal direction from point within a distance of 7 cm in a caudal direction from the xiphoid process to a point within a cranial or caudal distance of 5 cm from the iliac crest. In this application, in a mounted position of the support belt, the long sides or edges thereof are termed cranial and caudal sides or edges, respectively. In this application the one short side or edge of the abdominal support belt of the invention that is overlapped by the belt in a mounted position is termed inner short side or edge whereas the other short side or edge is termed outer short side or edge.

According to a preferred aspect of the invention the abdominal support belt comprises a means preventing it from being displaced in a caudal direction. The displacement preventing means can be an adhesive means disposed between the support belt and the patient's skin, that is, on the face of the support belt facing the patient's skin, or one or more ribbons of the support belt extending from the support belt at its cranial side or edge and of a length allowing it or them to be secured to a body part or structure disposed distally thereof during CPR, such as around the patient's neck or the frame or back plate of a CPR apparatus.

More specifically the of the invention comprises mounting the abdominal support belt of the invention to a patient in need of CPR without applying pressure to the abdomen; optionally mounting a CPR apparatus to the patient; administering CPR to the patient manually or by means of the CPR apparatus for a period of time sufficient for resuscitation.

The abdominal support belt of the invention is preferably used with reciprocating CPR apparatus that compress the sternum of a patient but its use is not restricted to such apparatus. It may also be used, for instance, with CPR apparatus that cyclically tighten the chest of a patient, such as vest-like CPR apparatus, or when manually administering chest compressions to a patient.

The invention will now be explained in more detail by reference to preferred embodiments thereof illustrated in a drawing.

### SHORT DESCRIPTION OF THE FIGURES

FIGS. 1a and 1b show, in a sectional view, a person under CPR in absence of abdominal stabilization, the thoracic cage being shown in an uncompressed state (1a) and in a compressed state (1b);

FIGS. 2a and 2b show, in the same view and the same states, an abdominally stabilized person under CPR;

FIGS. 3a and 3b show a first embodiment of the abdominal support of the invention, in a mounted state, in a median plane sectional view at (FIG. 3a); in a dismounted state, in a top view (FIG. 3b) of its outer face;

FIGS. 4a and 4b show a second embodiment of the abdominal support of the invention, in a mounted state, in a median plane sectional view (FIG. 4a) corresponding to that of FIG. 3a; in a dismounted state, in a top view (FIG. 4b) of its inner face;

FIGS. 5a and 5b show a third embodiment of the abdominal support of the invention, in a mounted state, in a median plane sectional view (FIG. 5a) corresponding to that of FIG. 3a; in a dismounted state, in a top view (FIG. 5b) of its outer face;

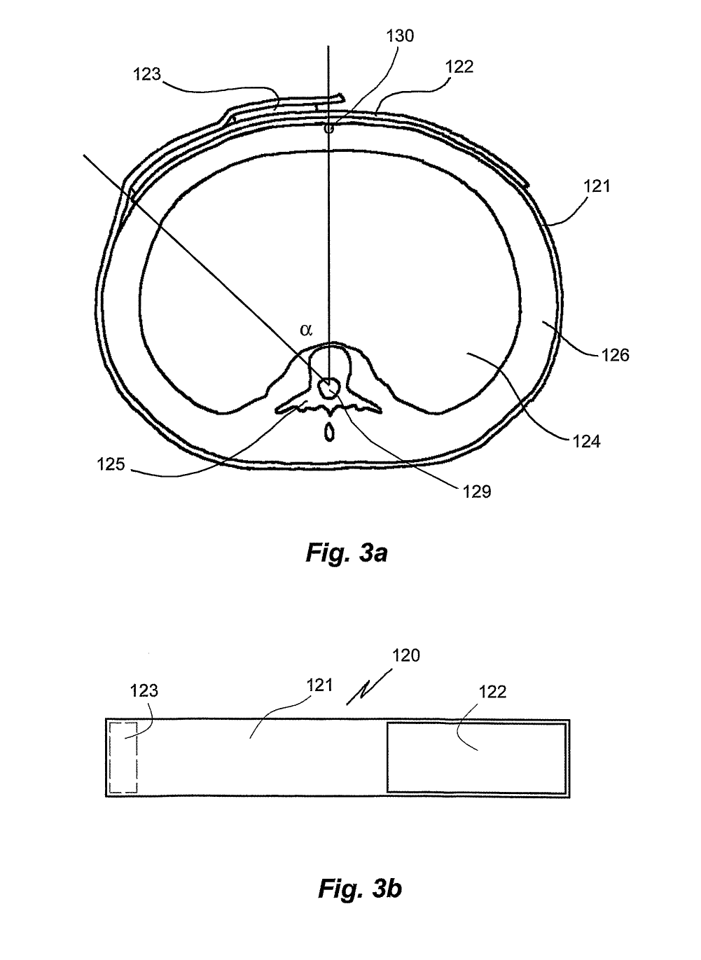

The top views of FIGS. 3b, 4b, 5b are rendered at a reduced scale in respect of the corresponding sectional views of FIGS. 3a, 4a, 5a, which are transverse sections in a plane slightly cranially of the umbilicus.

### DESCRIPTION OF PREFERRED EMBODIMENTS

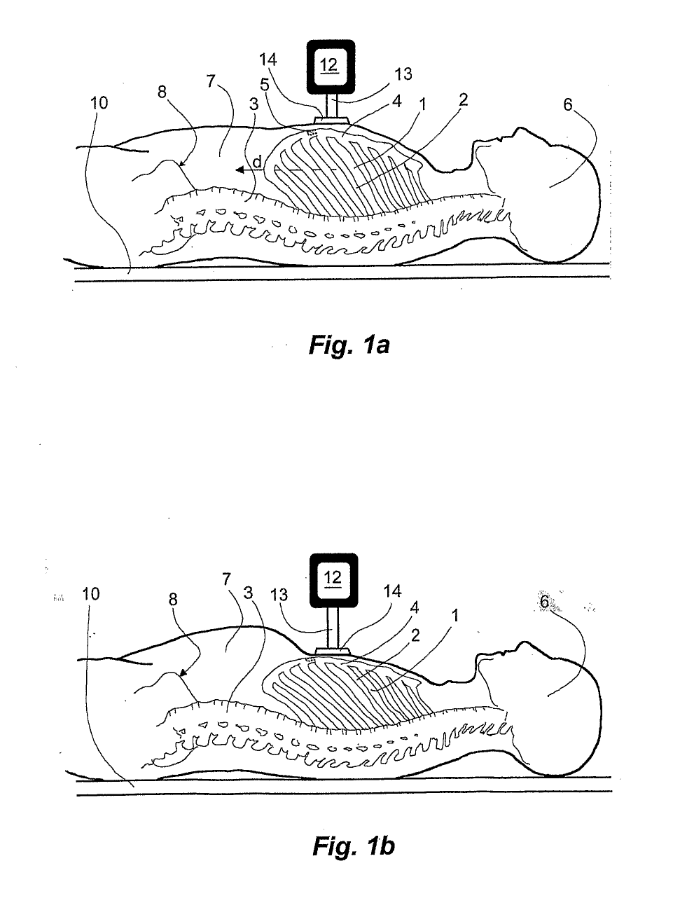

FIGS. 1a and 1b illustrate a non-abdominally stabilized person receiving CPR according to the state of the art. In FIG. 1a a patient is shown in a recumbent position resting with his back and head 6 on a flat support 10. A cardiopulmonary resuscitation apparatus 12 is mounted above the patient's chest by means of a frame comprising the support 10 and two legs (not shown) extending from opposite sides of the support 10 so as to encircle the thoracic cage of the patient. A plunger 13 provided with a circular compression pad 14 at its lower end extends downwards from the CPR apparatus 12. The compression pad 14 rests on the patient's chest above the body of the sternum 4 section bordering the xiphoid process 5. The thoracic cage encloses the thoracic cavity 1. The thoracic cavity 1 is defined by the ribs 2, the vertebral column 3, the sternum 4, and the cranially/caudally displaceable diaphragm, which separates it from the abdominal cavity 7. The abdominal cavity 7 is enclosed by the abdominal wall and, in the context of the present invention, is considered to extend in a caudal direction substantially until about the iliac crest 8. Since, in a patient under CPR, the muscles of the abdominal wall are not under nervous control, the abdominal wall is easily extended and the abdominal cavity 7 expanded by a rise in intra-abdominal pressure. Such a rise in abdominal pressure is caused by the plunger 13/compression disk 14 assembly pushing the sternum 4 towards the spine 3 at their (13, 14) downward chest compressing movement, while displacing tissues of the thoracic cavity 1 in a caudal direction d (FIG. 1b). The expansion of abdominal cavity 7 is evident from FIG. 1b.

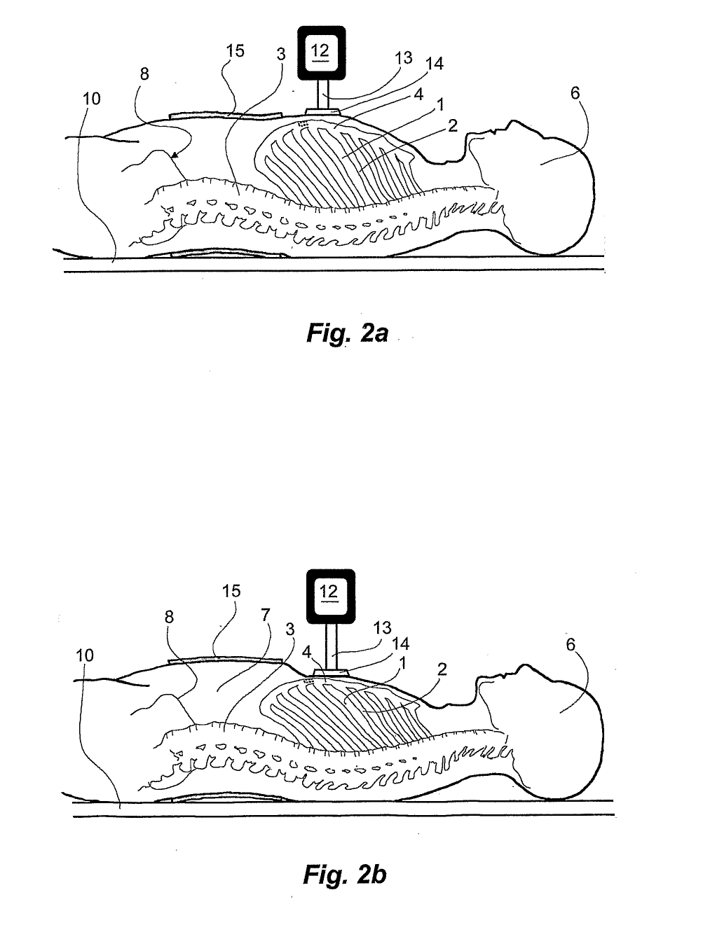

FIGS. 2a and 2b illustrate the patient of FIGS. 1a and 1b in an abdominally stabilized state according to the method of the invention under CPR. The arrangement of the cardiopulmonary resuscitation apparatus 12 is the same as in FIG. 1a. The reference numbers in FIGS. 2a and 2b refer to the same features as those in FIGS. 1a and 1b. Abdominal stabilization is effected by an abdominal support belt 15 of the kind illustrated in FIGS. 3a-3c mounted around the patient's belly. When the chest of the patient is compressed by a downward displacement of thee plunger 13/compression disk 14 assembly, the abdominal support belt 15 hinders expansion of the abdominal cavity 7 and thus displacement of tissues of the thoracic cavity 1 in the direction of the abdominal cavity 7. The abdominal support belt 15 does however not hinder arterial blood expelled from the left ventricle of the heart during chest compression from passing through the abdominal cavity via large arteries, such as the abdominal aorta and its branches. The stabilization or preservation of the volume of the thoracic cavity 7 during chest compression in an abdominally supported person under CPR results in arterial blood being more efficiently expelled from the left ventricle as well as air from the lungs. This is also beneficial for maintaining adequate cerebral blood perfusion.

FIGS. 3a, 3b, in which reference numbers 124, 125, 126 designate the abdominal cavity, the spine and the abdominal wall, respectively, illustrate a first preferred embodiment 120 of the abdominal support belt of the invention. Reference number 130 refers to the projection of the umbilicus perpendicular to the drawing plane while reference number 129 refers to the spinal channel. The support belt 120 comprises a rectangular sheet 121 of woven nylon thermally stabilized at its edges against tearing. The sheet 121 has an inside facing the patient's belly when applied and an outside facing away from the belly. Over a section extending from one short end of the sheet 121 a Velcro™ pad 122 is affixed to the outer face of the sheet 121 by sewing. Near the other short end of the sheet 121 another Velcro™ pad 123 is similarly affixed to the inner face of the sheet 121. The abdominal support belt 120 is so dimensioned that it can be wrapped around the belly of an obese adult person, for instance of a sheet 121 length of 150 cm, allowing for sufficient overlap of its end portions. The support belt 120 is locked in the wrapped position by the co-operating Velcro™ pads 122, 123. The length of the pad 122 should be selected so as to allow the support belt 120 to be safely mounted on a slender person also. For a sheet 121 length of 160 cm a pad 122 of 80 cm length is adequate. The length of the second Velcro™ pad 123 is not critical but its area, for instance an area of 200 cm², should be large enough to ensure good interlocking with the pad 123. The support belt 120 has a width about 20 cm to 30 cm so as to be fit for enclosing the belly from about the free end of the xiphoid process to about the iliac crest. The support belt 120 is mounted around the patient's belly as shown in FIG. 3b in a manner disposing the connection between the Velcro™ pads in the vicinity of the umbilicus.

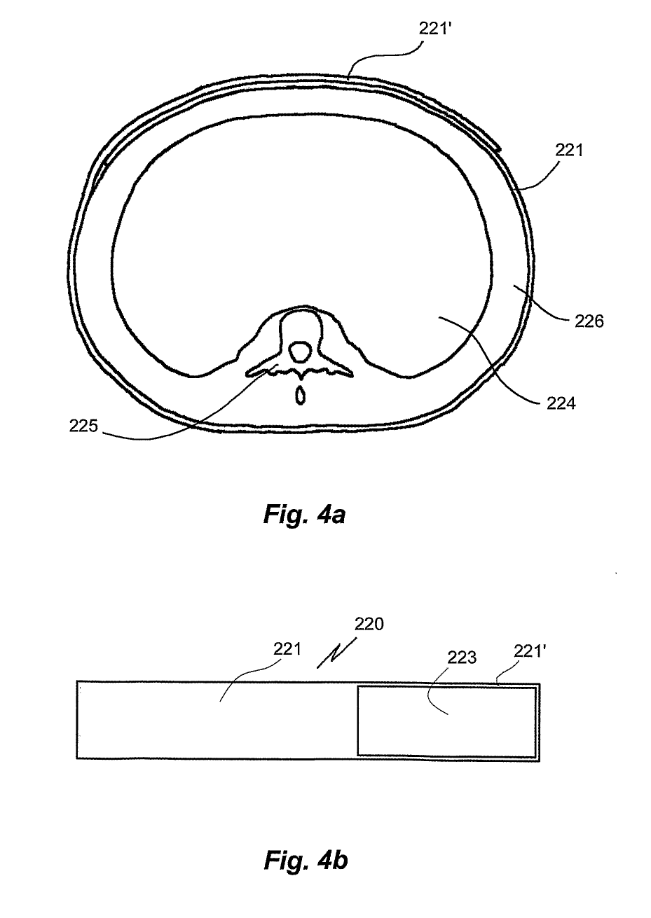

FIGS. 4a-4c, in which reference number 224 designates the abdominal cavity, reference number 225 the spine and reference number 226 the abdominal wall, illustrate a second preferred embodiment 220 of the abdominal support belt of the invention. The support belt 220 comprises a rectangular sheet 221 of strong cotton fabric. The sheet 221 has an inside facing the patient's belly when applied and an outside facing away from the belly.

The inside of the sheet 221 is covered with a latex based adhesive covered by a protective sheet 223 of silanized kraft paper. The protective sheet 223 is torn off prior to use. The abdominal support belt 220 is so dimensioned that it can be wrapped around the belly of an obese adult person, allowing for a sufficient overlap, for instance comprising a sheet 221 length of 150 cm. The belt 220 is locked in this position by adhering to the patient's skin. The length of the sheet 221 portion 221′ covered by adhesive should be selected so as to allow the support belt 220 to be safely mounted on a slender person also. The support belt 220 has a width about 20 cm to 30 cm so as to be fit for enclosing the belly from about the free end of the xiphoid process to about the iliac crest. The support belt 220 is mounted around the patient's belly as shown in FIG. 4b.

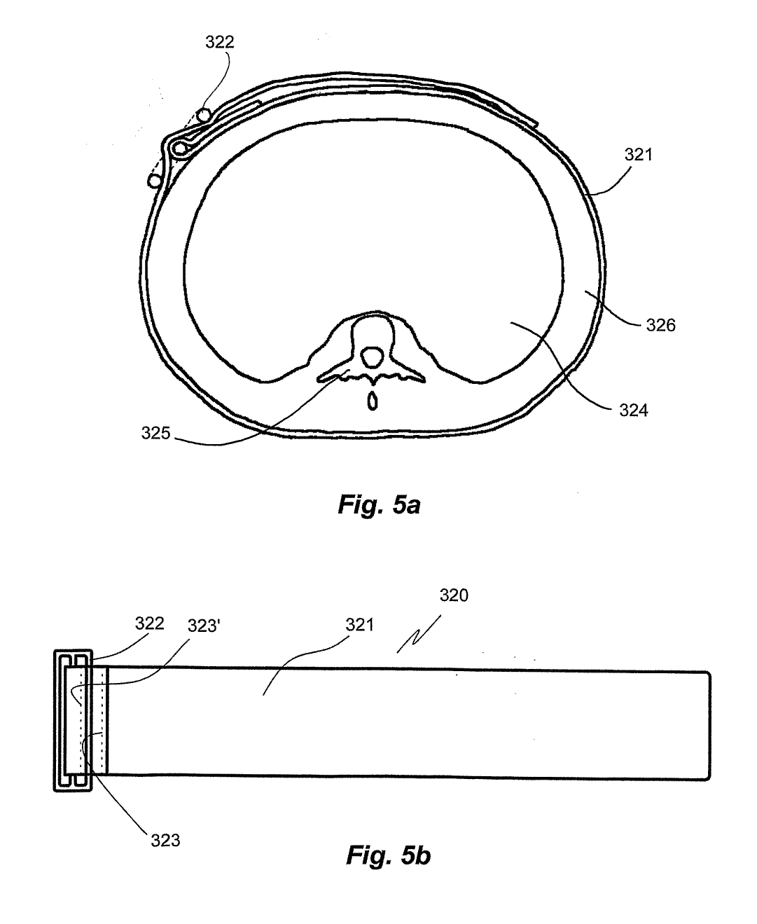

FIGS. 5a, 5b, in which reference numbers 324, 325, 326 designate the abdominal cavity, the spine and the abdominal wall, respectively, illustrate a third preferred embodiment 320 of the abdominal support belt of the invention. The support belt 320 comprises a rectangular sheet 321 of polyethylene fabric thermally stabilized at its edges against tearing. At one short end of the sheet 321 is affixed a friction belt buckle 322 by wrapping a sheet portion extending from that end around the central cross bar of the buckle 322 and joining the end portion to the main portion by stitched seams 323, 323′. The support belt 320 is locked by inserting the other short end of the sheet 321 into the belt buckle 322 then pulling tight. The abdominal support belt 320 is so dimensioned that it can be wrapped around the belly of an obese adult person, for instance comprising a sheet 321 length of 150 cm or 160 cm, allowing for a sufficient overlap, and locked in this position. The support belt 320 has a width about 20 cm to 30 cm so as to be fit for enclosing the belly from about the free end of the xiphoid process to about the iliac crest. The support belt 320 is mounted around the patient's belly as shown in FIG. 5b.

In the method of the invention the abdominal support belt is mounted so that its cranial long side becomes disposed caudally of the xiphoid process and its caudal long side becomes disposed cranially of the iliac crest. Furthermore the abdominal support belt is preferably mounted so as to make its inner short side define an angle a originating in the spinal channel 129 with the projection of the umbilicus 130 of from 30° to 90° (FIG. 3b), the support belt extending one turn from the inner short side over the umbilicus around the abdomen until overlapping the short side. The support belt should only be tensioned during mounting so as to make it fit tightly around the abdomen but not make it compress the abdomen in a manner that abdominal tissue is displaced in a cranial direction. After mounting of the belt compressions are administered to the chest of the patient at a rate of from 60 min⁻¹ to 150 min⁻¹. Alternatively, the support belt may be mounted during CPR but this is not preferred.

1. A method of abdominally stabilizing a patient selected for CardioPulmonary Resuscitation (CPR) and whose chest is in an uncompressed state, comprising wrapping a substantially inextensible flexible belt around the abdomen substantially without applying pressure to the abdomen; locking the belt in the wrapped position, wherein the belt does not comprise an inflatable member such as an inflatable bladder.

2. The method of claim 1, wherein the mounted belt extends from a first point within a caudal distance from the xiphoid process of from 0 mm to 70 mm to a second point within a cranial distance from the iliac crest of 50 mm or a point disposed caudally of the second point.

3. The method of claim 1, comprising securing the belt to the patient or an apparatus used in providing chest compressions to the patient in a manner to prevent displacement of the belt in a caudal direction.

4. The method of claim 3, wherein the belt is adhesively secured to the patient.

5. The method of claim 3, wherein the belt is secured to the patient or apparatus by ribbon(s) or similar.

6. The method of claim 1, wherein the belt is locked by means of adhesive, belt buckle, Velcro™ tape, hooks and eyes.

7. A method of providing CPR to a person in need thereof, comprising abdominally stabilizing the person by the method of claim 1; administering chest compressions to the person at a rate of from 60 per min to 150 per min for a time sufficient to restore spontaneous circulation.

8. The method of claim 7, wherein the compressions are administered by hand.

9. The method of claim 7, wherein the compressions are administered by a disk disposed on the person's sternum actuated via a reciprocating rod driven by a piston in a cylinder or an electric motor.

10. A belt for abdominal stabilization during CPR of a flexible but substantially nonextensible material and comprising a locking means selected from adhesive, Velcro™ tape, buckle, hooks and eyes, the belt being of generally rectangular shape with long sides of from 80 cm to 140 cm or more and short sides of from 15 cm to 40 cm or more, preferably of from about 20 cm to about 30 cm, with the proviso that the belt does not comprise an inflatable member such as an inflatable bladder.

11. The belt of claim 10, comprising a displacement preventing means for securing it to the patient or a CPR apparatus or other structure being in a fixed spatial relationship with the patient during CPR.

12. The belt of claim 11, wherein the displacement preventing means comprises adhesive disposed at the face of the support belt facing the patient's skin.

13. The belt of claim 11, wherein the displacement preventing means comprises one or more ribbons of the support belt extending from the support belt at its cranial side or edge and of a length allowing it or them to be secured to a body part or structure disposed distally thereof during CPR, such as around the patient's neck or the frame or back plate of a CPR apparatus.

14. A method of preserving the integrity of the thoracic cage in a patient selected for CPR by means of a CPR apparatus designed to administer periodical compressions to the patient's chest, preservation of integrity being accomplished by reducing the depth of compression of the chest at maintained compression efficiency, comprising abdominally stabilizing the patient in a condition in which the patient's chest is in an uncompressed state by wrapping a substantially inextensible flexible support belt around the patient's abdomen substantially without applying pressure to the abdomen to enclose the abdomen in the tightly fitting belt; locking the belt in the wrapped position, administering compressions to the patient's chest, wherein the belt does not comprise an inflatable member such as an inflatable bladder.

15. The method of claim 14, wherein the support belt comprises an adhesive means on its face facing the patient in an applied state.

16. The method of claim 14, wherein the support belt comprises one or more ribbons extending from the belt at its cranial side or edge and of a length allowing it or them to be secured to a body part or structure disposed distally thereof during CPR, such as around the patient's neck or the frame or back plate of a CPR apparatus.

17. A method of increasing cardiac output and blood pressure in CPR administered to a patient at a maintained compression depth, comprising abdominally stabilizing the patient in a condition in which the patient's chest is in an uncompressed state by wrapping a substantially inextensible flexible support belt around the patient's abdomen substantially without applying pressure to the abdomen to enclose the abdomen in the tightly fitting belt; locking the belt in the wrapped position, administering compressions to the patient's chest, wherein the belt does not comprise an inflatable member such as an inflatable bladder.

18. The method of claim 17, wherein the support belt comprises an adhesive means on its face facing the patient in an applied state.

19. The method of claim 17, wherein the support belt comprises one or more ribbons extending from the belt at its cranial side or edge and of a length allowing it or them to be secured to a body part or structure disposed distally thereof during CPR, such as around the patient's neck or the frame or back plate of a CPR apparatus.

20. The method of claim 17, wherein cardiac output is increased by 5% or more.

21. The method of claim 17, wherein cardiac output is increased by 10% or more.
